(19) United States
(12) Patent Application Publication
(10) Pub. No.: US 2019/0313676 A1
(43) Pub. Date: Oct. 17, 2019

(54) BOILED PORK BOSSAM AND PREPARATION METHOD THEREFOR

(71) Applicant: EVERIT CO., LTD., Daejeon (KR)

(72) Inventors: Young Hwan Lee, Daejeon (KR); Eun Su Jung, Daejeon (KR)

(21) Appl. No.: 16/452,934

(22) Filed: Jun. 26, 2019

Related U.S. Application Data
(63) Continuation of application No. PCT/KR2017/013326, filed on Nov. 22, 2017.

(30) Foreign Application Priority Data
Dec. 28, 2016 (KR) 10-2016-0180866

(51) Int. Cl. A23L 13/00; A23L 13/40; A23L 5/10

(52) U.S. Cl. CPC A23L 13/03; A23L 13/40; A23L 5/11; A23V 2250/21; A23L 5/13; A23V 2002/00; A23L 13/06

(57) ABSTRACT

The present invention relates to boiled pork which has improved flavor and taste as a result of keeping the unique savory taste of fat and preventing the loss of meat juice while effectively removing animal fat during preparation thereof, and to a standardized preparation method capable of preparing the boiled pork with uniform quality, and more particularly to boiled pork having on its surface a film formed by frying in oil and a method for preparing the same.

### CROSS-REFERENCE TO RELATED APPLICATION

This is a continuation of International Application No. PCT/KR2017/013326, with an international filing date of Nov. 22, 2017, which claims the benefit of Korean Application No. 10-2016-0180866 filed on Dec. 28, 2016, the entire contents of which applications are incorporated herein by reference.

### TECHNICAL FIELD

The present invention relates to boiled pork which has improved flavor and taste as a result of keeping the unique savory taste of fat and preventing the loss of meat juice while effectively removing animal fat during preparation thereof, and to a method capable of preparing the boiled pork with consistent quality by a standardized process.

### BACKGROUND ART

The annual meat consumption per capita in South Korea in 2014 is a total of 45.1 kg, of which pork consumption is 21.5 kg. Pork contains group B vitamins in amounts which are 5 to 10-fold more abundant than beef, and also contains large amounts of good quality proteins and nutrients which have the effect of making the skin shiny. Furthermore, a large amount of iron contained in pork has a high absorption rate in vivo, and thus has an excellent effect of preventing iron deficiency anemia. In addition, pork fat has a lower melting point than the human body temperature, and therefore has an excellent detoxification function of discharging pollutants, such as mercury or lead, which are caused by air pollution and fine dust inhalation, from the body.

In South Korea, roasted pork belly has the highest preference among pork, but when pork belly is roasted directly over fire, a problem arises in that benzopyrene, which is a carcinogenic substance, can be produced during the cooking process. Boiled meat, which is prepared by boiling meat in water or steaming meat, is not exposed to high-temperature heat during the cooking process, and thus the production of carcinogenic substances therein can be suppressed and unhealthy animal fat and antibiotics can be removed therefrom, indicating that it can provide safe food. However, a conventional method of preparing boiled meat by water-boiling or steaming is used, not only unhealthy components, but also useful components, including nutrients, and the original taste of pork, come out into the water, thus reducing the original flavor of pork and making the meat dry. To overcome this disadvantage of the conventional method of preparing boiled meat, Korean Patent No. 10-0817354 discloses a method of boiling meat by heating in a state in which the meat is placed on green onion, without using water. However, this method does not overcome the problem that the original taste and nutrients of pork are lost, because the amount of green onion used reaches ⅙ to ½ of the meat weight and the meat is boiled by green onion-derived water and meat-derived broth, even though water is not additionally added. Besides, even though meat is boiled in a lid-closed state, a problem arises in that a meat portion not submerged in water is dried and becomes stiff Korean Patent No. 10-0647104 discloses a technique of preparing boiled meat by heating after covering meat with a cotton cover and hanji (traditional Korean paper), followed by covering with a bamboo chick coated with red clay, and then closing the side with red clay. However, this method of preparing boiled meat uses a complicated cooking process and has low economic efficiency because it is not easy to reuse the red clay and bamboo chick used. Korean Patent No. 10-0597891 discloses a method of preparing pork Bossam by covering pork with hanji and an aluminum foil and roasting the covered pork over hardwood charcoal fire. However, this method may be regarded as a cooking method for one close to “barbecue pork” rather than “boiled pork”. Korean Patent No. 10-1180426 discloses a method of preparing boiled pork by smoking pork in a smoker and then heating the pork in a constant-temperature water bath. This method is characterized in that a film is formed on the surface of pork in the smoking process during preparation of the boiled pork, thereby reducing the loss of meat juice during the boiling process and improving the softness of the pork, and in that the sensory properties are increased due to smoke flavor and the storage stability of the pork is increased. The smoking process is performed at 50 to 60° C. for 10 minutes to 2 hours, and thus has the effect of adding smoke flavor, but has problem in that it is time-consuming and requires a separate device and equipment besides cooking utensils. In addition, since the temperature of the smoking process is low, a large amount of meat juice can be lost before a film is formed on the meat surface, and thus the effect of the film is not sufficient. Furthermore, the tightness and thickness of the film formed in the smoking process are not sufficient, and therefore the effect of preventing the loss of meat juice in a subsequent boiling process is not sufficient.

Meanwhile, in order to supply boiled meat as a product, the supply and demand of materials should be easy, additional installation and operation costs due to special equipment or facilities should not be incurred, thus ensuring economic efficiency, and it should be possible to repeatedly produce a product having uniform quality irrespective of cooking rounds. However, in conventional methods of preparing boiled meat, it is not easy to provide a uniform environment in a cooking process, and hence the error between cooking rounds can inevitably occur, making it difficult to control the taste and flavor of prepared boiled meat at constant levels.

More precisely, meat boiled in water or steamed is defined as boiled meat', and a food obtained by slicing boiled meat' to eat together with Chinese cabbage hearts or bossam kimchi is defined as ‘bossam’ However, ‘boiled meat’ and ‘bossam’ are used interchangeably in everyday life. Considering this, in the specification, ‘bossam’ is used with the same meaning as ‘boiled meat’.

### DISCLOSURE

### Technical Problem

An object of the present invention is to provide boiled pork having excellent sensory properties due to a protein coagulation film formed on the surface thereof so as to retain meat juice inside the film.

Another object of the present invention is to provide a method capable of preparing boiled pork with uniform quality by a standardized method without having to use special facilities or equipment.

Still another object of the present invention is to provide a method of preparing boiled pork, which removes harmful substances such as fat and antibiotics, keeps the advantages of boiled pork, such as light taste, overcomes the disadvantage that meat juice is lost in a boiling or steaming process, making the meat dry and resulting in a reduction in the sensory properties, and adds the savory taste of heat-treated fat obtainable in roasted foods.

### Technical Solution

The present invention for accomplishing the above-described objects is directed to boiled pork comprising a film on its surface by frying in oil.

The film may have a thickness of 0.5 to 5 mm. If the thickness of the film is excessively thick, the surface may be tough and hard, and if the thickness of the film is overly thin, the effect of trapping meat juice inside the film in a cooking process can be insufficient.

The present invention is also directed to a method for preparing boiled pork, comprising steps of: (A) cutting pork to a predetermined size; (B) flying the cut pork in oil to form a film on the surface of the pork; and (C) boiling the fried pork in water or steaming the fried pork.

### Advantageous Effects

The boiled pork of the present invention as described above has a film on its surface formed by protein coagulation, and thus has meat juice retained therein. Thus, it retains the original flavor of pork and has excellent sensory properties.

According to the boiled pork preparation method of the present invention as described above, it is easy to provide a uniform cooking environment without having to use special equipment or facilities, and thus it is possible to prepare highly marketable boiled pork having uniform quality irrespective of cooking rounds.

In addition, according to the preparation method of the present invention, in the process of flying the cut pork in oil to cook the surface before boiling or steaming of the pork, animal fat that can cause arteriosclerosis and the like is mostly removed, and at the same time, is partially substituted with vegetable fat which keeps the savory flavor, and the unique light taste of boiled pork can also be provided. In the frying process, the oil temperature can be easily controlled and a uniform temperature can be transferred throughout the pork, and thus the appearance can be colored without concern about carcinogenic substances that are produced at high temperatures.

In addition, according to the preparation method of the present invention, a film is formed on the surface of the cut pork within a short time in the process of flying the surface of the cut pork in high-temperature oil, and thus the loss of meat juice can be prevented, thus providing boiled pork having excellent sensory properties.

### DESCRIPTION OF DRAWINGS

FIG. 1 is a photograph of pork after frying before steaming in one example of the present invention.

FIG. 2 is a photograph of boiled pork prepared in one example of the present invention.

FIG. 3 is a photograph of sliced boiled pork prepared in one example of the present invention.

FIG. 4 is a photograph of boiled pork prepared in a comparative example.

FIG. 5 is a photograph of sliced boiled pork prepared in a comparative example.

FIG. 6 is a photograph comparing the sections of boiled pork prepared in an example of the present invention and boiled pork prepared in a comparative example.

### BEST MODE

Hereinafter, the present invention will be described in further detail with reference to examples. The drawings and examples are given for the understanding of the disclosure of the present invention and not intended to limit or change the scope of the claims in the present invention. It is apparent to those skilled in the art that various modifications and changes are available within the scope of the claims in the present invention based on the examples.

The present invention is directed to a method for preparing boiled pork, comprising steps of: (A) washing and cutting pork to a predetermined size; (B) flying the cut pork in oil to form a film on the surface of the pork; and (C) boiling the fried pork in water or steaming the fried pork.

In the present invention, among pork parts, pork belly or pock neck, which is often used as the material of boiled pork, is preferably used as raw material pork, but is not limited thereto.

Step (A) is a step of cutting pork to a predetermined size. Although the size of pork does not need to be particularly limited, it is more preferable to predetermine the cutting size so as to make it possible to produce pork meat having uniform quality irrespective of cooking rounds, in order to produce commercial pork meat. For example, the predetermined cutting size may be about 10 cm×6 cm×30 cm, but this size is a randomly set value, and thus it is, of course, possible to select an appropriate size in consideration of the size of a cooking utensil or the size of boiled pork sliced after cooking.

Either performing a washing step or removing blood to remove the meat smell before or after cutting of the pork is included in ordinary meat cooking procedures, and thus detailed explanation thereof will be omitted. It is also natural that the washing step includes a process of removing connective tissue and excessive fat.

The method of the present invention may further comprise, before the step (B) which is a substantial cooking step, a step of aging the pork. In the aging process, muscles that became stiff during slaughtering are loosened, the meat is softened, the texture becomes better, and the flavor is improved. The aging may be performed by any of a dry aging method and a wet aging method.

In addition, in the aging process, the pork may be aged in a state in which it is mixed with an herb or an oriental herbal extract. For dry aging, the herb or the oriental herbal extract may be added as a solid or an extract. The herb is added in order to remove meat smell from the pork and add unique fragrance, and examples thereof include, but are not limited to, clove, laurel leaves, basil, Rosemary, sage, and the like. The oriental herbal extract is obtained by extraction of one or more selected from the group consisting of ginseng, red ginseng, Schisandra chinensis, Chinese matrimony vine, Pueraria lobata Ohwi, Siberian chrysanthemum, cinnamon bark, Perilla frutescens var. acuta, milk vetch root, jujube, antler, dong quai, kalopanax and licorice, and when it is aged in a state in it is mixed with the pork, it has the effects of softening the flesh of the pork and removing meat smell from the pork, and the beneficial components of the herbal material can be absorbed into the pork, thus imparting functionality.

The aging process is preferably performed at a temperature of −5 to 10° C. for 12 to 48 hours, and more preferably, performed at a temperature of −2 to 5° C. for 18 to 24 hours. As the aging time increases, the economic efficiency decreases, and the pork can be easily spoiled because the proportion of white muscle fibers in the pork is high.

Step (B) is a step of frying the pork, cut to a predetermined size, in oil to cook the surface. In this step, a film is formed by protein coagulation while the surface is cooked, thereby preventing water penetration or the loss of meat juice in the step (C) of boiling the fried pork in water or steaming the fried pork. In addition, in the frying process, unsaturated animal fat is mostly removed and partially substituted with vegetable fat, and thus the savory taste of the fat can be maintained, thus further improving the flavor of the pork. Even after the boiled pork gets cold, the phenomenon that fat coagulates white is suppressed, and thus the boiled pork has excellent sensory properties even when it is eaten immediately after cooking or in a cold state. In addition, the surface is colored brown, and thus sensory properties in terms of the appearance are improved.

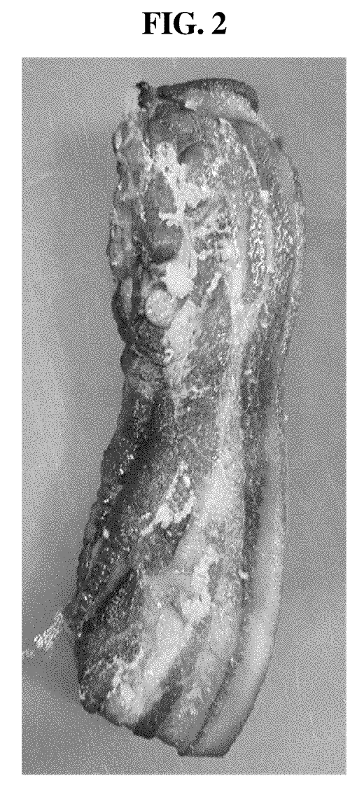

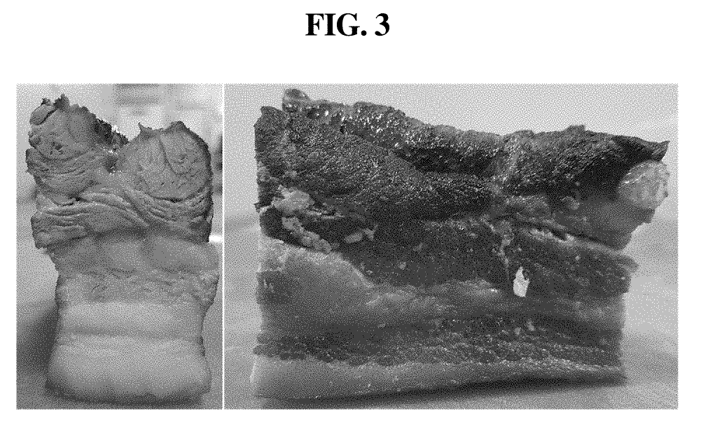

FIGS. 2 and 3 show photographs of boiled pork and sliced boiled pork, respectively, prepared in one example of the present invention. It can be seen that a thin film formed by a process of flying pork in oil is present on the surface of the boiled pork.

The oil that is used in this step may be a vegetable oil, such as soybean oil, canola oil, sunflower oil, corn oil or grape seed oil, which has no heavy scent and has a high smoke point. When meat protein is heated at a temperature of 220° C. or above, benzopyrene, a carcinogenic substance, can be produced. For this reason, the flying temperature in this step is preferably 180 to 220° C. If the temperature is excessively low, the oil may penetrate into the pork and damage the unique light taste of the boiled meat. Since this step is not intended to cook the pork thoroughly, it is sufficient that the surface is cooked to form a protein coagulation film, and the appearance is cooked to golden brown so that it has an excellent color sense. Thus, it is sufficient that the frying time is 2 to 5 minutes. When the pork is put in the flying oil, the temperature of the frying oil is lowered. For this reason, it is preferable that after the flying oil is sufficiently preheated to a temperature of 210 to 220° C., the pork is put and fried therein.

When a large amount of pork is cooked, a fly basket may be used to easily adjust the frying time. When pork is put in the fry basket which is then put in heated oil and taken out of the oil after a predetermined time, there is no difference in the time of exposure to the oil, and thus boiled pork can be prepared with uniform quality.

Since this step is intended to simply cook the surface, but also to color the surface to make a more pleasant shape, frying of the pork is preferably performed such that the shape is not disturbed as much as possible and the pork is colored evenly. To this end, flying of the pork is preferably performed in a state in which the cut pork pieces are arranged such that they are not in contact with each other. If there is a portion that makes contact between the pork pieces, this portion cannot be fried in oil, making it impossible to obtain a good-quality color. In addition, when the pork pieces are arranged in the fry basket such that fat-rich portions rather than flesh portions touch the fry basket, the pork will not stick to the fly basket, and thus the shape will not be disturbed and the pork may be in an ordered form.

Step (C) is a step of boiling the pork, the surface of which has been cooked by frying in the oil, in water, or steaming the pork. In this step, the inside of the pork is also cooked, but meat juice is not lost because the surface protein has already been coagulated by cooking.

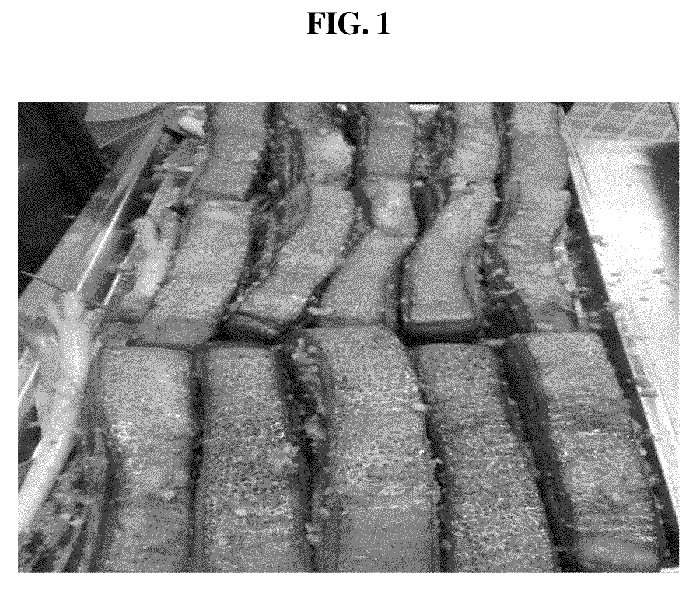

In this step, boiling in water or steaming is more preferably performed in a state in which the fried pork of step (B) is mixed with one or more minor ingredients selected from the group consisting of green onion, ginger, laurel, garlic, and clove. When the pork is boiled in water, the minor ingredients may be added to and boiled in the water. When the pork is steamed, the pork fried in step (B) may be steamed after placed on and/or under the minor ingredients depending on the shape of the minor ingredients, or steamed after the minor ingredients are applied evenly to the pork surface (see FIG. 1). The minor ingredients may be used in a prepared state or in a thinly sliced state, and may also be used in a powdery or crushed state. The minor ingredients have the effects of not only removing meat smell from the final boiled pork, but also improving the sensory properties of the boiled pork through smooth permeation of the unique fragrance thereof.

The boiled pork prepared in step (C) may be transferred into another container before getting cold, and then cooled to a core temperature of 0 to 10° C., after which it may be distributed and stored at a temperature of −2 to 10° C. If the boiled pork is cooled naturally in the boiling water or the steamer, the fat and debris that came out during the boiling or steaming process can be absorbed again into the pork. It is natural that the boiled pork may be packaged in a predetermined unit for distribution.

### EXAMPLES

Preparation Example: Preparation of Boiled Pork

Domestically produced pork belly was cut to a size of 10 cm×6 cm×20 cm. The cut pork was immersed in water at 5 to 10° C. for 4 hours to remove the blood. After 1 hour of immersion, the water was replaced with fresh one. The blood-removed pork was aged in a refrigerator at −2 to 5° C. for 24 hours. The aged pork was taken out, and water on the surface was removed by cotton cloth, after which the pork was put in cooking oil (preheated to 215° C.) and fried therein for 3 hours.

Green onion was prepared clean and laid in one layer on a steaming tray, and thinly sliced ginger and laurel leaves were additionally laid thereon. Finely ground garlic was applied evenly to the surface of the fried pork belly which was then placed on the tray (see FIG. 1) and steamed for 60 minutes. Next, the pork belly was transferred into another container before getting cold.

Comparative Example: Preparation of Boiled Pork according to Conventional Art

Boiled pork was prepared in the same manner as described in the Example above, except that the frying process was omitted.

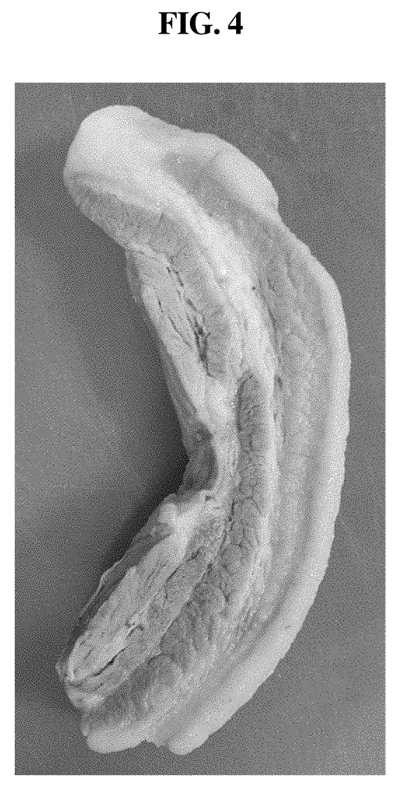

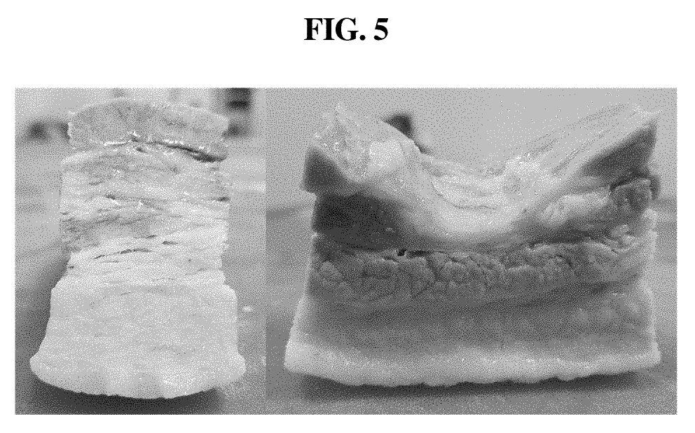

FIGS. 2 and 3 are photographs of boiled pork and sliced boiled pork, respectively, prepared in the Example of the present invention. It can be seen that a thin film formed by the oil frying process is present on the surface of the boiled pork. FIGS. 4 and 5 are photographs of boiled pork and sliced boiled pork, respectively, prepared in the Comparative Example, and it can be seen therein that no film is present on the surface, unlike the Example.

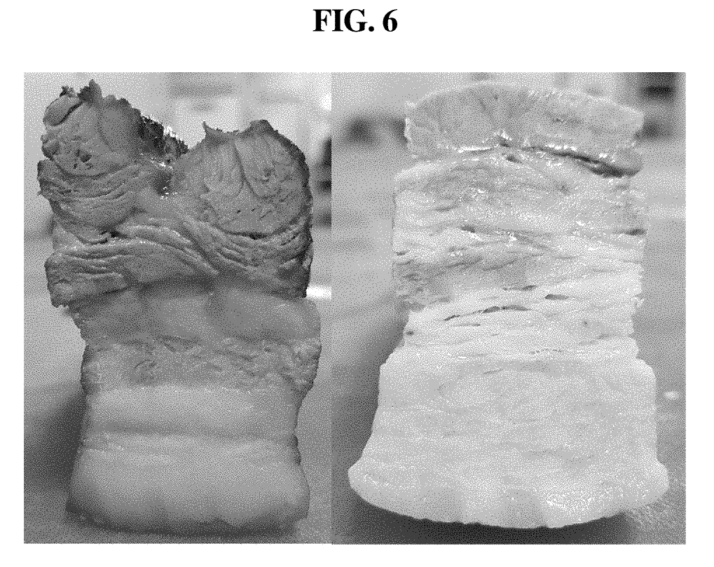

The presence or absence of the film is dramatically contrasted in FIG. 6, which is a photograph comparing the sections of the boiled pork prepared in the Example of the present invention and the boiled pork prepared in the Comparative Example. Furthermore, the flesh of the pork according to the present invention is more hard and chewy and darker in color than that of the Comparative Example. This is believed to be because the formed film prevents the penetration of external water or the discharge of internal meat juice in the steaming process (or boiling process).

Test Example: Sensory Evaluation

In order to examine the sensory difference between the boiled pork prepared in the Preparation Example and the Comparative Example, six 20s to 40s men and women who were experienced in sensory evaluation were selected as panels, and sensory evaluation was performed using a 9-point scale (1: very poor; 9: very good). The results of the sensory evaluation are shown in Table 1 below. As sensory properties, the appearance, flavor, chewiness, taste and overall preference of each sample were evaluated. To this end, the samples of the Preparation Example and the Comparative Example were cut to a uniform size, put in white dishes labeled with a 3-digit random number, and presented together with water.

TABLE 1

| | Preparation Example | Comparative Example |
|---|---|---|
| Appearance | 8.5 | 7.6 |
| Flavor | 8.4 | 7.4 |
| Chewiness | 7.9 | 7.6 |
| Taste | 8.4 | 7.4 |
| Overall preference | 8.5 | 7.6 |

What is claimed:

1. Boiled pork comprising a film formed on its surface by frying in oil.

2. A method for preparing boiled pork, comprising steps of:
(A) cutting pork to a predetermined size;
(B) frying the cut pork in oil to form a film on a surface of the pork; and
(C) boiling the fried pork in water or steaming the fried pork.

3. The method of claim 2, further comprising a step of aging the pork, before the step (A) or between the step (A) and the step (B).

4. The method of claim 3, wherein the aging is performed in a state in which the pork is mixed with an herb or an oriental herbal extract.

5. The method of claim 3, wherein the aging is performed at a temperature of −5 to 10° C. for 12 to 48 hours.

6. The method of claim 4, wherein the aging is performed at a temperature of −5 to 10° C. for 12 to 48 hours.

7. The method of claim 2, wherein in the step (B), the frying is performed in the oil at a temperature of 180 to 220° C. for 2 to 5 minutes.

8. The method of claim 3, wherein in the step (B), the frying is performed in the oil at a temperature of 180 to 220° C. for 2 to 5 minutes.

9. The method of claim 2, wherein, in the step (C), the fried pork from the step (B) is boiled in water or steamed in a state in which the fried pork is mixed with one or more ingredients selected from the group consisting of green onion, ginger, laurel, garlic, and clove.

10. The method of claim 3, wherein, in the step (C), the fried pork from the step (B) is boiled in water or steamed in a state in which the fried pork is mixed with one or more ingredients selected from the group consisting of green onion, ginger, laurel, garlic, and clove.

11. The method of claim 2, further comprising a step of cooling the pork boiled or steamed from the step (C) to a core temperature of 10° C. or below, and then a step of storing the cooled pork at a temperature of −2 to 10° C.

12. The method of claim 3, further comprising a step of cooling the pork boiled or steamed from the step (C) to a core temperature of 10° C. or below, and then a step of storing the cooled pork at a temperature of −2 to 10° C.
